(19) United States
(12) Patent Application Publication
(10) Pub. No.: US 2011/0317794 A1
(43) Pub. Date: Dec. 29, 2011

(54) NUCLEAR FUEL ASSEMBLY AND RELATED METHODS FOR SPENT NUCLEAR FUEL REPROCESSING AND MANAGEMENT

(76) Inventors: Francesco VENNERI, Los Alamos, NM (US); Lance Lewis SNEAD, Knoxville, TN (US)

(21) Appl. No.: 13/153,371

(22) Filed: Jun. 3, 2011

Related U.S. Application Data
(60) Provisional application No. 61/351,016, filed on Jun. 3, 2010.

(51) Int. Cl. G21G 1/06; G21C 3/02; G21C 3/32

(52) U.S. Cl. 376/170; 376/434; 376/414

(57) ABSTRACT

Various embodiments of a nuclear fuel assembly and related methods for processing and managing spent nuclear fuel are disclosed. According to one exemplary embodiment, a nuclear fuel may include a plurality of first fuel rods having a plurality of first fuel elements and a plurality of second fuel rods having a plurality of second fuel elements. Each of the first fuel elements may include uranium dioxide fuel, and each of the second fuel elements may include a plurality of tristructural isotropic fuel particles embedded in a silicon carbide matrix. The plurality of first fuel rods and the plurality of second fuel rods are arranged in a fuel assembly.

### CROSS-REFERENCE TO RELATED PATENT APPLICATION

This patent application claims priority to U.S. Provisional Application No. 61/351,016, filed on Jun. 3, 2010, the contents of which are incorporated by reference in their entirety herein.

### STATEMENT OF FEDERALLY SPONSORED RESEARCH

The United States Government has certain rights in this invention pursuant to Contract No. DE-AC05-00OR22725 between the United States Department of Energy and UT-Battelle, LLC.

### FIELD OF THE INVENTION

Various embodiments of the present invention relate generally to nuclear technologies. More specifically, particular embodiments of the invention relate to nuclear fuel assemblies and related methods for processing and managing spent nuclear fuel.

### DESCRIPTION OF RELATED ART

Nuclear waste migration, storage, and disposal incur significant costs, safety risks, and environmental concerns. As societal demands for power increase and pressure grows to reduce dependence on non-renewable energy resources, nuclear power represents a large-scale and reliable source of energy. Yet, the degree of use and acceptance of nuclear power will at least in part depend on whether the nuclear industry finds acceptable ways to deal with problems associated with nuclear waste.

One method of reducing nuclear waste is to increase consumption, or burnup, of nuclear fuel. This can be done by increasing the fraction of fission per initial heavy metal atom in the nuclear fuel, which reduces the overall spent fuel volume so that long-life radioactive isotope inventories can be significantly reduced. Increasing fuel burnup extracts more energy per unit mass of fuel, thereby lengthening the fuel cycle, reducing fuel consumption and overall fuel cost.

However, prior attempts to increase the fuel burnup rate has only achieved a consumption rate of around 5% and therefore are only marginally successful at reducing partially burned fuel inventories. Such low burnup rates represent incomplete consumption of fuel with partially-burned transuranic waste remaining in the spent nuclear fuel, disposal of which poses environmental concerns. The spent nuclear fuel with partially-burned transuranic waste is currently being stored on a nuclear reactor site, and reactor operators must deal with large and growing inventories of spent nuclear fuel.

### BRIEF SUMMARY OF THE INVENTION

Therefore, there is a need for increasing the burnup rate of nuclear fuel to reduce the volume of transuranic waste, thereby reducing costs for operators of nuclear reactors in dealing with the spent nuclear fuel. There is also a need for providing ways to re-use legacy transuranic material in a conventional reactor, so it can be deep-burned for easy storage and/or disposal while extracting additional power from the fuel.

Although the present invention may obviate one or more of the above-mentioned problems or deficiencies, it should be understood that some aspects of the invention might not necessarily obviate all or some of those problems or deficiencies.

To attain the advantages and in accordance with the purpose of the invention, as embodied and broadly described herein, one aspect of the invention may provide a nuclear fuel comprising: a plurality of first fuel rods comprising a plurality of first fuel elements, each of the first fuel elements comprising uranium dioxide fuel; and a plurality of second fuel rods comprising a plurality of second fuel elements, each of the second fuel elements comprising a plurality of tristructural isotropic fuel particles containing transuranic elements embedded in a silicon carbide matrix. The plurality of first fuel rods and the plurality of second fuel rods may be arranged in a fuel assembly for a light water reactor.

According to another exemplary aspect, the plurality of first fuel rods are disposed in the fuel assembly substantially surrounding the plurality of second fuel rods.

In still another exemplary aspect, the plurality of second fuel rods may comprise less than approximately 40% of a total number of fuel rods in the fuel assembly. More specifically, the plurality of second fuel rods may comprise about 20% to about 30% of the total number of fuel rods in the fuel assembly.

In some exemplary aspects, each of the second fuel elements may comprise a substantially cylindrical fuel pellet in which the plurality of tristructural isotropic fuel particles are embedded. Each of the plurality of tristructural isotropic fuel particles may comprise a fuel kernel and a ceramic layer surrounding the fuel kernel.

According to another exemplary aspect, each of the first and second fuel rods may comprise a tubular enclosure defining an interior space for housing the plurality of first and second fuel elements, respectively, and an outer surface configured to contact a coolant of a nuclear reactor.

In another exemplary aspect, each of the plurality of second fuel rods may comprise an elongated tubular enclosure in which the plurality of second fuel elements having a form of a substantially cylindrical pellet are stacked along a longitudinal axis of the tubular enclosure.

In various exemplary aspects, the plurality of first and second fuel rods may be configured for use in a light water reactor.

Another exemplary aspect may also provide a method of managing nuclear fuel. The method may comprise combining a plurality of first fuel rods having UO₂ fuel elements with at least one second fuel rod having micro-encapsulated fuel elements in a fuel assembly. The micro-encapsulated fuel elements may comprise a plurality of tristructural isotropic fuel particles embedded in a SiC matrix. The method may also comprise irradiating the plurality of first fuel rods and the at least one second fuel rod in a nuclear reactor.

According to one exemplary aspect, the method may further comprise, after the irradiating step, processing the UO₂ fuel elements of the plurality of first fuel rods to make micro-encapsulated fuel elements containing transuranic material for later use and disposing of the at least one second fuel rod.

In another exemplary aspect, the method may further comprise varying the number of second fuel rods in the fuel assembly based on an amount of legacy transuranic material to be disposed of within a predetermined safety limit. In addition, the method may comprise selecting the number of second fuel rods to be combined with the plurality of first fuel rods in the fuel assembly, such that the amount of transuranic material to be generated during irradiation of UO₂ fuel elements is balanced with the amount of legacy transuranic material to be disposed of during irradiation of the micro-encapsulated fuel elements.

In still another exemplary aspect, the at least one second fuel rod \may comprise less than approximately 40% of a total number of fuel rods in the fuel assembly. In some exemplary embodiments, the at least one second fuel rod may comprise about 20% to about 30% of the total number of fuel rods in the fuel assembly.

According to one exemplary aspect, the nuclear reactor comprises a light water reactor.

In some exemplary aspects, the method may further comprise fabricating the plurality of tristructural isotropic fuel particles from legacy tranuranic material.

In another exemplary aspect, the irradiating step comprises irradiating the fuel assembly in a nuclear reactor until a fuel burnup of at least 50% in the transuranics fuel elements is reached, whereby the legacy transuranic material in the micro-encapsulated fuel elements are substantially burned.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a schematic illustration of various constituents of a nuclear fuel assembly according to one exemplary embodiment consistent with the present invention.

FIG. 2 is a schematic illustration of a nuclear fuel assembly according to one exemplary embodiment consistent with the present invention.

FIG. 3 is a schematic illustration of various portions of a fuel element according to one exemplary embodiment consistent with the present invention.

FIG. 4 is a graph illustrating the relationship between nuclear reactivity versus burnup rate for different types of nuclear fuel material according to one exemplary embodiment consistent with the present invention.

FIG. 5 is a graph illustrating the transuranic mass as compared to the fuel burnup in a balanced condition in which no net amount of material is added to waste inventory, according to one exemplary embodiment consistent with the present invention.

FIGS. 6A and 6B are schematic, cross-sectional views of a fuel assembly (e.g., of a boiling water reactor), illustrating a balanced combination of fuel rods according to one exemplary embodiment consistent with the present invention.

FIG. 7 is a graph illustrating the changes in transuranic waste inventory according to one exemplary embodiment consistent with the present invention.

### DETAILED DESCRIPTION OF EXEMPLARY EMBODIMENTS

In the following description, reference is made to the exemplary embodiments consistent with the present invention, examples of which are illustrated in the accompanying figures. Wherever possible, the same reference characters will be used throughout the figures to refer to the same or like parts. It should be understood that other embodiments can be utilized to practice the present invention, and structural and functional modifications can be made thereto without departing from the scope of the present invention.

As will be described herein, various disclosed embodiments of the present invention may greatly facilitate nuclear fuel management, specifically as it pertains to, among other things, (1) combining fuels in different quantitative configurations to both increase flexibility in manufacturing nuclear fuel assemblies based on material stockpiles and to increase energy to generate more power from a nuclear reactor, and 2) what to do with large stockpiles of partially-burned nuclear material extracted from spent fuel.

The disclosed embodiment may use such partially-burned nuclear material to formulate usable fully ceramic, micro-encapsulated transuranic (FCM TRU) fuel, thereby greatly reducing waste backlog and improving environmental conditions. Additionally, a “deep burn” process according to the present invention results in practically complete destruction of legacy transuranic material, since such legacy transuranic material from spent fuel can be recycled into FCM TRU fuel and used in combination with uranium oxide fuel for another nuclear reaction.

Therefore, the disclosed exemplary embodiments consistent with the present invention may teach a nuclear fuel assembly and methods of structuring nuclear fuel assemblies that result in improvements in nuclear fuel reprocessing and management and disposing of legacy nuclear waste.

The term “transuranic waste” or “transuranic material,” as used herein, refers to any material containing significant quantities of plutonium, americium, or other elements whose atomic weights exceed that of Uranium. The term “legacy transuranic material,” as used herein, refers to, for example, transuranic materials generated from prior use of the materials, such as, for example, wastes in spent nuclear fuel.

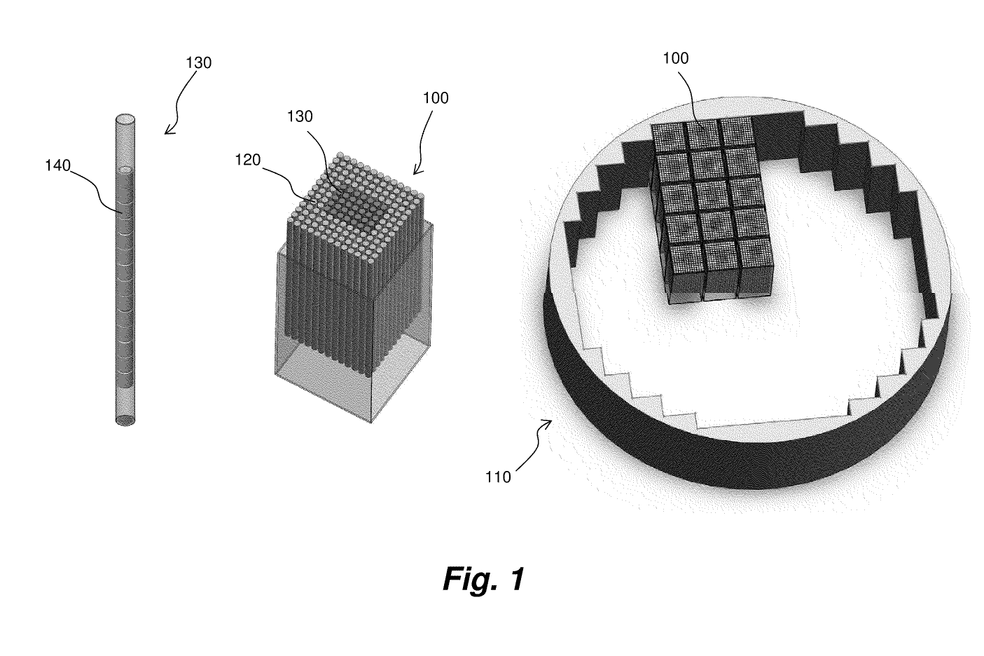

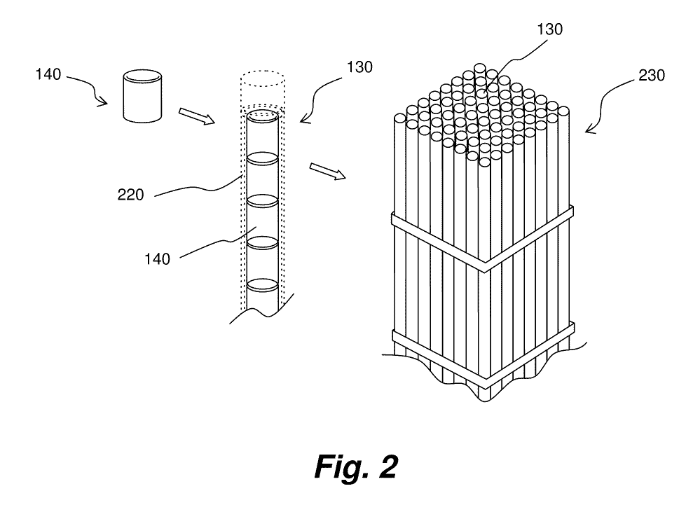

FIG. 1 and FIG. 2 illustrate various constituents of a nuclear reactor core 110 according to one exemplary embodiment. Reactor core 110 comprises a plurality of fuel assemblies 100 (or fuel bundle). Each of the fuel assemblies 100 may comprise two different types of fuel rods: (1) a first fuel rod 120 containing a plurality of conventional uranium dioxide (UO₂) fuel element with low enrichment level; and (2) a second fuel rod 130 containing a plurality of fully ceramic, micro-encapsulated (FCM) fuel elements 140. FCM fuel elements 140 may contain transuranic (TRU) material.

First and second fuel rods 120 and 130 are bundled together in a variety of configurations in a discrete manner, so that the two different types of nuclear fuel are heterogeneously present in a fuel assembly 100 of a nuclear reactor. First and second fuel rods 120 and 130 may form the fuel assembly 100 within the nuclear fuel assembly 100.

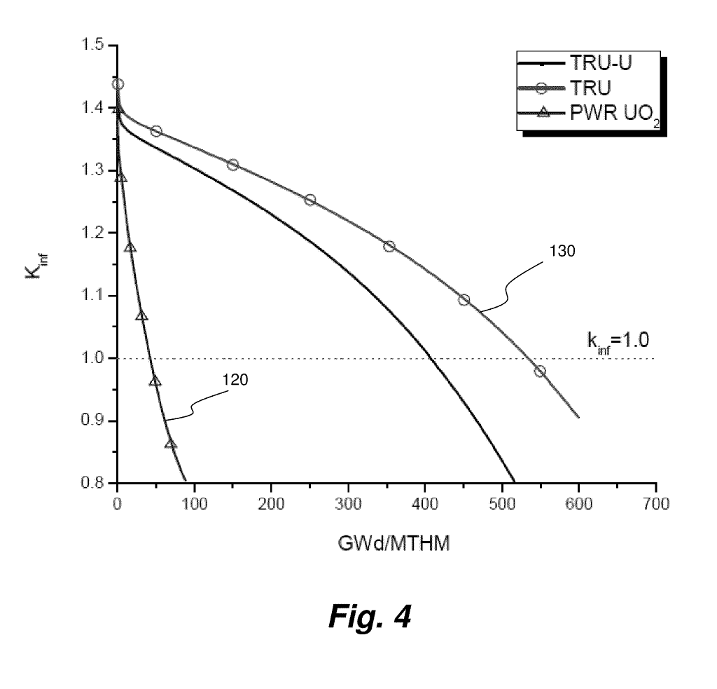

In some exemplary aspects, configurations of fuel rods 120 and 130 may vary depending on the amount of FCM TRU fuel 130 to be fully burned, and therefore the number of fuel rods 140, to be included in the rod array 160. Homogeneous fuel rod arrays in which only one type of fuel are used exhibit specific reactivity characteristics when irradiated in a nuclear reaction that may limit the amount of burnup rate, or fuel consumption, in a nuclear reactor. However, as shown in FIG. 4, nuclear reactivity behavior in discrete, bundled configurations of rods with different kinds of fuel can be used in light water reactors (LWRs) to achieve much higher burnup rates, of around 50 GWd/MTHM in the LEU fuel (which is typical of light water reactor fuels) and over 500 GWd/MTHM in the FCM TRU fuel.

The much higher burnup rate that can be obtained in the FCM TRU component of the nuclear fuel indicates that one can achieve “deep burn” of the transuranic isotopes and therefore utilize the discrete, bundled configurations of the present invention in the management of spent fuel generated by light water reactors. Combining the reactivity characteristics of nuclear material in both types of fuel to achieve such a “deep burn” reduces the drawbacks of using each type of fuel individually and results in a much higher fuel burnup rate.

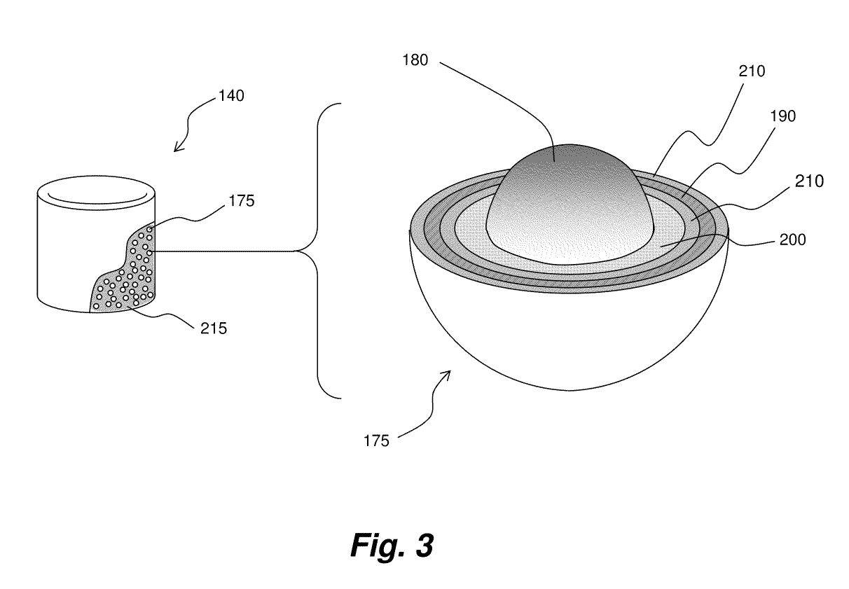

Transuranic material used as FCM TRU nuclear reactor fuel 130 according to the present invention may comprise tristructural isotropic (TRISO) ceramic-coated fuel particles, as shown in FIG. 3. When using plutonium or a mix of transuranic isotopes produced in a typical light water reactor, FCM TRU fuel 130 can achieve a significant excess reactivity, sufficient to be used as fuel in the existing light water reactors in conjunction with regular uranium oxide fuel, in configurations compatible with existing reactor cores. TRU fuel is a spent fuel by-product of irradiating regular uranium oxide fuel, such as the low enriched uranium fuel used in various exemplary embodiments of the present invention. This TRU fuel is fully ceramic micro-encapsulated and can be re-used together with fresh low enriched uranium fuel in bundle configurations according to the present invention.

Nuclear fuel assembly 100 may comprise of a plurality of first and second fuel rods 130 and 140, each comprising a plurality of fuel elements or pellets housed inside an elongated cladding tube 220 to form the respective first and second fuel rods 130 and 140. As shown in FIG. 2, pellets 140 may have any shape suitable for use in a fuel rod in a conventional light water nuclear reactor, such as, for example cylindrical, spherical or elongated shape depending on the type of nuclear reactor in which it will provide fuel.

According to one exemplary aspect of the invention, the first fuel type and the second fuel type may have substantially identical outer appearance and configurations.

As best shown in FIG. 3, TRISO fuel kernels 180 are surrounded by several layers of material, including but not limited to layers formed of ceramic material 190, a buffers of porous carbon, and layers of pyrolytic carbon. For example, a TRISO fuel kernel may be coated with four layers of three isotropic materials: a porous buffer layer 200 made of carbon, a dense inner layer of pyrolytic carbon 210, followed by a layer of the ceramic material 190 to retain fission products at elevated temperatures and to give the TRISO particles in the fuel kernels more structural integrity, followed by a dense outer layer of pyrolytic carbon 210. The ceramic material 190 forming this layer may be a silicon carbide material and/or a zirconium carbide material, or any other suitable material having similar properties and compatible with the reactor cladding and coolant. TRISO particles 175 may embedded in a matrix material 215 (e.g., silicon carbide) to form a fuel pellet 140.

Fuel pellets 140 are positioned inside a tubular enclosure 220, such as a metallic or ceramic cladding tube or other suitable enclosure, to form a fuel rod 130. Tubular enclosure 220 may provide an additional barrier for the nuclear fuel element. One or more fuel rods 120 and 130 may then be placed in a fuel bundle 230 or assembly for use as part of the core 110 in a light water reactor.

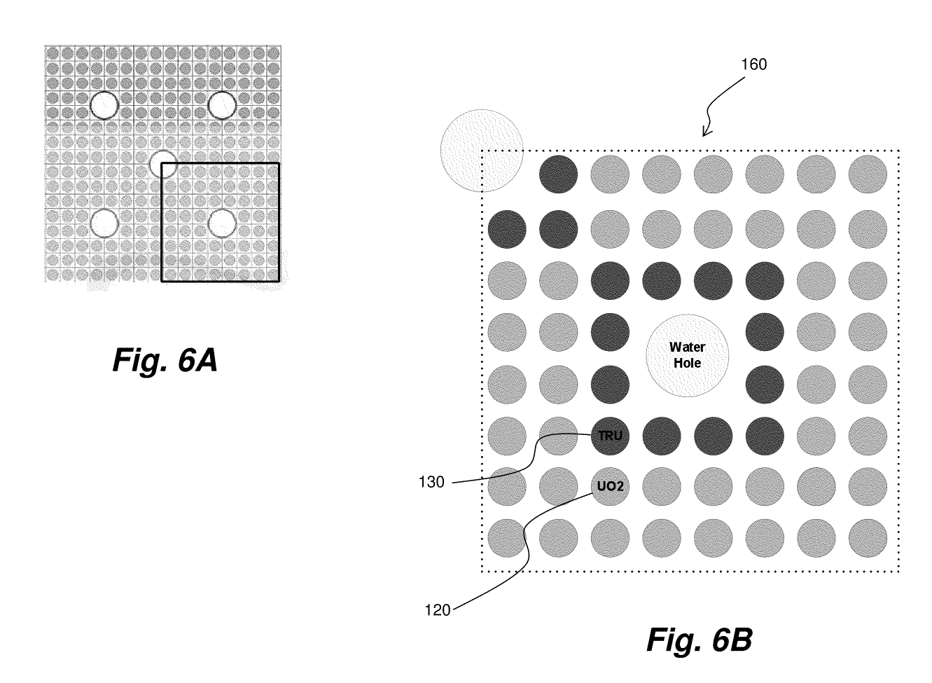

A fuel core 110 may include a plurality of fuel assembly 100 each having a plurality of fuel rods 120 and 130. Fuel assemblies 100 may also include one or more water holes, as shown FIG. 6B, positioned to provide room for control rods and other mechanisms.

Fuel density of TRISO particles in a FCM TRU fuel rod 130 is typically between 500 and 1000 particles per centimeter, and power production from burnup is between 0.2 and 0.3 Watts per particle. This results from the reactivity behavior of the TRISO particles in the deep burn process, measured as reactivity K_{inf} and variable dependent on lattice material configurations 215 inside fuel pellets 140, and the packing fraction of TRISO particles in a FCM TRU fuel rod 130.

The use of different matrix materials 215 may result in different calculations of reactivity K_{inf} behavior for fuel having the same packing fraction, yet only slight changes in relation to the difference in calculation of reactivity behavior when higher packing fractions are used, within a range of packing fractions. For example, in a carbon matrix 215 with a packing fraction of 30%, one can expect the reactivity K_{inf} for FCM TRU fuel 130 to be 1.444. Use of silicon carbide as a matrix 215 for the same packing fraction may reduce reactivity K_{inf} to 1.431. Comparing this to reactivity in a carbon matrix 215 with a packing fraction of 35%, where one can expect K_{inf} for FCM TRU fuel 130 to also be 1.444, while the use of silicon carbine as a lattice matrix 215 for the same packing fraction reduces reactivity K_{inf} 130 to 1.432. This may indicate that fuel density measured as a packing fraction can be varied in the deep burn process and still achieve optimum reactivity within a certain packing fraction range.

The upper and lower limits of the packing fraction of TRISO fuel particles in relation to low enriched uranium is dependent on a safety analysis and the amount of TRISO fuel to be consumed, as too much TRU TRISO fuel represents an unstable reactivity situation. Typically, no more than 40% of fuel in a bundle can be comprised of TRU TRISO fuel due to reactivity instability concerns. The lower limit of the packing fraction may depend on targeted burnup rate of the amount of legacy TRU material to be consumed.

FIG. 4 shows a plot of K_{inf} reactivity behavior and burnup rate in a deep burn process, measured as gigawatt days per metric ton of heavy metal, in a light water reactor in which FCM TRU fuel 130 having a silicon carbide lattice and packing fraction of 30% is plotted, together with uranium oxide fuel 120 for comparison. FIG. 4 shows that burnup rates of higher that 600 GWd/MTHM are possible, and therefore, where bundles 230 of FCM TRU fuel 130 of 30% are used, the designer can expect much larger rates of burnup in the FCM TRU fuel than with single-fuel fuel assemblies containing conventional uranium oxide fuel mixed with TRU fuel.

FIG. 4 illustrates the K_{inf} reactivity behavior of TRU fuel 130, indicating a large initial excess reactivity for FCM TRU 130 fuel, with a K_{inf} of over 1.4. This is to be compared with the K_{inf} reactivity behavior of low enriched uranium oxide fuel 120. From FIG. 4, it may be possible to conclude that fuel bundles 230 made of low enriched uranium oxide fuel 120 and FCM TRU fuel 130 can be used in light water reactors to achieve burnup rates of about 50 GWd/MTHM in the low enriched uranium fuel 120, which is typical of existing light water reactor fuels, and over 500 GWd/MTHM in the FCM TRU 130 fuel. The large burnup rate that can be obtained in the FCM TRU fuel 130 indicates that it is possible to achieve “deep burn” of the transuranic isotopes in the FCM TRU fuel 130 and therefore be utilized in the waste management of the spent fuel generated by light water reactors.

Because of these reactivity characteristics, the deep burn process of the present invention may result in the deep burn of TRU material. Therefore, the combination of fuel rods 130 and 140 according to the disclosed embodiment consistent with the present invention may be ideal for use in the destruction of legacy, partially-burned transuranic material generated from previous nuclear reactions, as for example, in light water reactors, and in any other transuranic material, such as that derived from decommissioned nuclear weapons. Accordingly, FCM TRU fuel 130 may be used as fuel for a light water reactor to destroy the legacy, partially-burned transuranic material while, at the same time, generating power from it.

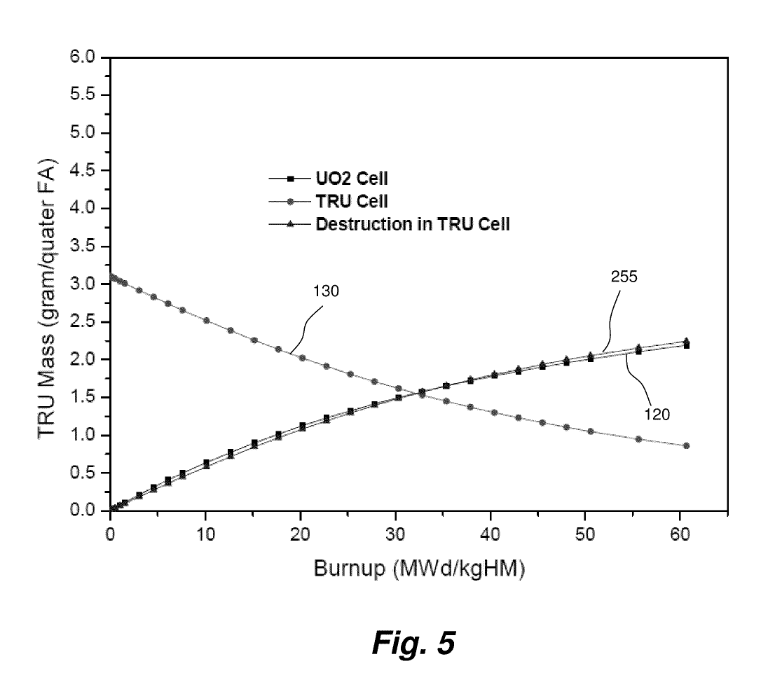

A balanced condition may exist where the burnup rate of the low enriched uranium fuel 120 roughly equals the deep burn of the transuranic material 255 in the FCM TRU fuel 130, so that no net addition is made to the inventory of partially-burned TRU material. FIG. 5 is a plot of TRU mass vs. burnup rate, for a TRISO packing fraction the fuel rod array 160 of up to 40%, together with a 0.2 molecular weight percentage of silicon carbide lattice matrix 215. FIG. 5 shows that the burnup rate of the low enriched uranium fuel 120 and the burnup rate of the TRU material inside FCM TRU fuel 130 are substantially equal at this packing fraction in a nuclear fuel assembly having a core comprised of a combination of fuels, indicating that at a packing fraction of up to 40%, TRU waste inventories are not increased. FIG. 6 is a graphical illustration of a balanced condition as described in the embodiment above, showing a discrete bundle of a combination of fuel rods 120 and 1\30 in which TRU waste inventories are not increased.

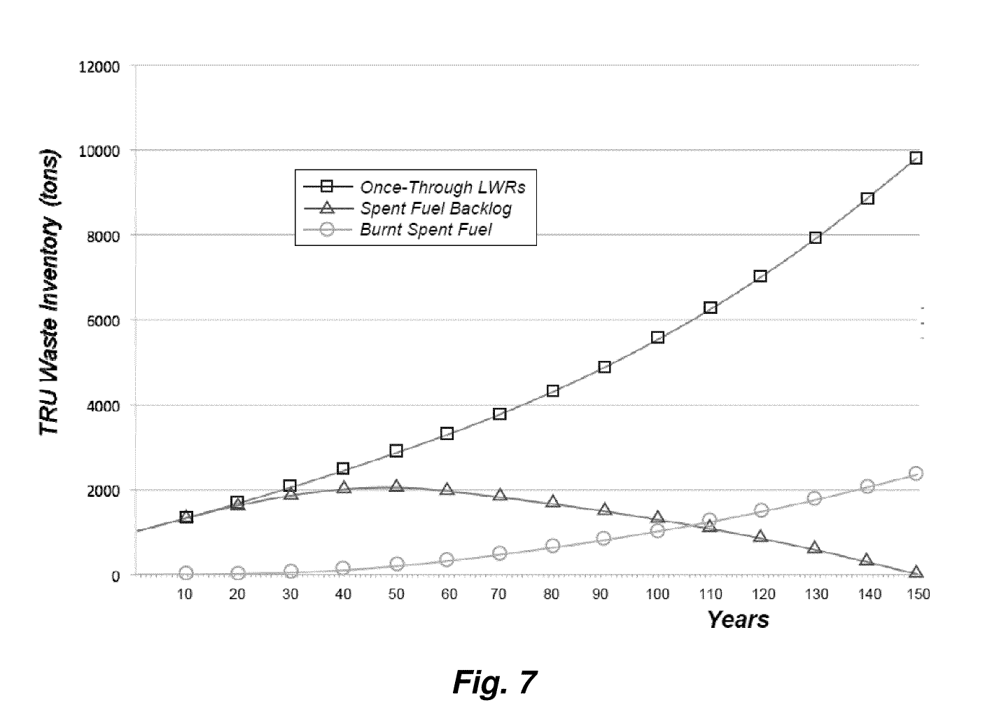

The present invention therefore allows the realization of significant benefits over conventional nuclear reactors. Turning to FIG. 7, it may be evident that a deep burn of transuranic material may have a significant impact on spent fuel management. FIG. 7 shows a plot of transuranic waste inventory in tons vs. years. Conventional light water reactors with cores comprised of homogeneous uranium oxide fuels result in increased transuranic waste inventories over time. Conversely, cores comprised of discrete combinations of fuels 120 and 130 result in both a significant reduction in existing spent fuel, transuranic waste inventories over time, and a far less difficult to manage increase in spent fuel from the deep burn process from the use of low enriched uranium fuel 120. Therefore, the deep burn process both reduces existing partially-burned spent fuel inventories and decreases, over time, the amount of partially-burned spent fuel added to the inventory. Other benefits realized from the deep burn process of the invention include a substantial reduction in TRU material mass and TRU waste mass, an increase in fuel utilization, and eliminating the weapons value of spent fuel as a result of the complete destruction of legacy TRU material.

It is to be noted that the present invention is compatible with use in existing and planned commercial light water nuclear reactors. Additionally, it is contemplated that the present invention is further compatible with all types of light water nuclear reactors, such as pressurized water reactors, boiling water reactors, and supercritical water reactors.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. For example, a nuclear fuel assembly according to the present invention may be modified for containment within other types of nuclear reactors, such as gas-cooled reactors, heavy water reactors, and liquid metal reactors. It is therefore intended that the scope of the invention be limited not by this detailed description.

What is claimed is:

1. A nuclear fuel comprising:
a plurality of first fuel rods comprising a plurality of first fuel elements, each of the first fuel elements comprising uranium dioxide fuel; and
a plurality of second fuel rods comprising a plurality of second fuel elements, each of the second fuel elements comprising a plurality of tristructural isotropic fuel particles embedded in a silicon carbide matrix, the tristructural isotropic fuel particles comprising transuranic elements,
wherein the plurality of first fuel rods and the plurality of second fuel rods are arranged in a fuel assembly.

2. The nuclear fuel of claim 1, wherein the plurality of first fuel rods are disposed in the fuel assembly substantially surrounding the plurality of second fuel rods.

3. The nuclear fuel of claim 1, wherein the plurality of second fuel rods comprise less than approximately 40% of a total number of fuel rods in the fuel assembly.

4. The nuclear fuel of claim 3, wherein the plurality of second fuel rods comprise about 20% to about 30% of the total number of fuel rods in the fuel assembly.

5. The nuclear fuel of claim 1, wherein each of the second fuel elements comprises a substantially cylindrical fuel pellet in which the plurality of tristructural isotropic fuel particles are embedded.

6. The nuclear fuel of claim 5, wherein each of the plurality of tristructural isotropic fuel particles comprises a fuel kernel and a ceramic layer surrounding the fuel kernel.

7. The nuclear fuel of claim 1, wherein each of the first and second fuel rods comprises a tubular enclosure defining an interior space for housing the plurality of first and second fuel elements, respectively, and an outer surface configured to contact a coolant of a nuclear reactor.

8. The nuclear fuel of claim 1, wherein each of the plurality of second fuel rods comprises an elongated tubular enclosure in which the plurality of second fuel elements having a form of a substantially cylindrical pellet are stacked along a longitudinal axis of the tubular enclosure.

9. The nuclear fuel of claim 1, wherein the plurality of first and second fuel rods are configured for use in a light water reactor.

10. A method of managing nuclear fuel, comprising:
combining a plurality of first fuel rods having UO₂ fuel elements with at least one second fuel rod having micro-encapsulated fuel elements in a fuel assembly, the micro-encapsulated fuel elements comprising a plurality of tristructural isotropic fuel particles embedded in a SiC matrix; and
irradiating the plurality of first fuel rods and the at least one second fuel rod in a nuclear reactor.

11. The method of claim 10, further comprising, after the irradiating step processing the UO₂ fuel elements of the plurality of first fuel rods to make micro-encapsulated fuel elements containing transuranic material for later use, and disposing of the at least one second fuel rod.

12. The method of claim 10, further comprising varying the number of second fuel rods in the fuel assembly based on an amount of legacy transuranic material to be disposed of within a predetermined safety limit.

13. The method of claim 12, further comprising selecting the number of second fuel rods to be combined with the plurality of first fuel rods in the fuel assembly, such that the amount of transuranic material to be generated during irradiation of UO₂ fuel elements is balanced with the amount of legacy transuranic material to be disposed of during irradiation of the micro-encapsulated fuel elements.

14. The method of claim 10, wherein the at least one second fuel rod comprises less than approximately 40% of a total number of fuel rods in the fuel assembly.

15. The method of claim 14, wherein the at least one second fuel rod comprises about 20% to about 30% of the total number of fuel rods in the fuel assembly.

16. The method of claim 10, wherein the nuclear reactor comprises a light water reactor.

17. The method of claim 10, further comprising fabricating the plurality of tristructural isotropic fuel particles from legacy transuranic material.

18. The method of claim 17, wherein the irradiating step comprises irradiating the fuel assembly in a nuclear reactor until a fuel burnup of at least 50% in the transuranic fuel elements is reached, whereby the legacy transuranic material in the micro-encapsulated fuel elements are substantially burned.
